(19) United States
(12) Patent Application Publication
(10) Pub. No.: US 2003/0198732 A1
(43) Pub. Date: Oct. 23, 2003

(54) Kind of fish sausage with fish meat block and its preparing method

(76) Inventor: Shan Wang, Beijing (CN)

Correspondence Address: LACKENBACH SIEGEL, ONE CHASE ROAD, SCARSDALE, NY, 10583, US

(21) Appl. No.: 10/419,665

(22) Filed: Apr. 21, 2003

(30) Foreign Application Priority Data
Apr. 23, 2002 (CN) 02117275.7

(51) Int. Cl. A23L 1/325

(52) U.S. Cl. 426/643

(57) ABSTRACT

The present invention relates to a kind of fish sausage with fish meat block, wherein the fish meat having certain shape is prepared by performing rough handling on the fish, then curing the fish and drying salted or cured fish by airing in shady and cool place or by heating, removing fish bone and foreign materials after the fish cools down. And the sausage according to the invention use the mixture of the fish meat having certain shape described above 20-90% weight and animal and poultry meat 1-49% weight as main material, and is prepared by conventional methods after supplementary material are added to the mixture. The present invention overcomes the defects of fish meat being shaped difficultly due to its fine fibres and high moisture content, and can keep the original flavor of fish to maximum extent in the sausage, so the sausage of the present invention is more delicious and better in taste than the existing fish sausage prepared by the minced fish meat and small fish. So the fish sausage of the present invention is the true fish sausage not only being better to eat but also people can feel the existing of the fish.

### FIELD OF THE INVENTION

The present invention relates to aquatic product process, more particularly to a kind of fish sausage with fish meat block and its preparing method.

### BACKGROUND OF THE INVENTION

Fish is a kind of aquatic product with high nutritive value, and people like to eat it. The conventional methods for processing it include dry salting and smoking, smoking, tinning, etc, or proceeding refrigeration transportation to meet the needs of the people who lives in the place where there is no aquatic product. Recently, the technology for preparing sausage with fish is developed greatly, which meets people's needs to some extent. But in the prior art, the fish sausage is prepared by adding the starch into the minced fish meat, then preparing the fish sausage by the conventional process of preparing sausage, such as Chinese patent CN1234990A, which disclosed a kind of method for preparing the fish sausage, although the technical solution disclosed in which solved the problem from starch to some extent, there are problems of dry and acerbity in taste, bad elasticity, single taste, etc, so people can not feel that there is fish in the sausage when they eat the sausage.

### SUMMARY OF THE INVENTION

One object of the invention is to overcome the defect that the fish is shaped difficultly due to its high moisture content and fine fibres. And at the same time, the invention can be used in large scope and develops a new method for processing aquatic product.

Another object of the invention is to keep the original flavor of fish to maximum extent in the sausage, so the sausage of the present invention is more delicious and better in taste than the existing fish sausage prepared by the minced fish meat and minced small fish. Thus the fish sausage will be a kind of true fish sausage that is tasteful to eat, and people can feel the existence of the fish.

In accordance with the present invention, one method of achieving aforesaid purpose includes steps: selecting a certain amount of fish, removing head, gut and scale of the fish; then salting the fish with salt or curing the fish with seasonings; the said seasonings include soya sauce, ground spices, paprika powder, etc; drying the salted or cured fish by heating or by airing in shady and cool place; steaming the dried fish for 15-30 minutes; then removing fish bone and foreign material after the fish cools down, and removing the skin of the fish which has rough skin; and then cutting the obtained fish meat into block, strip, slice, particle which is 0.2-10 cm in length and 0.2-5 cm in thickness. The minced meat from animal and poultry meat are prepared by conventional method.

After that, preparing the main material by fish meat having certain shape 20-90% weight, and animal and poultry meat 1-49% weight, then adding seasonings as supplementary material according to different taste, the percentage of weight of the seasonings is: refined salt 0.1-6, sugar 0.1-6, monosodium glutamate or chicken essence 0.1-5, natural flavorant 0.1-5, alcoholic liquor 0.1-4, soya sauce 0.1-5, ginger juice 0-3, paprika 0-3, pricklyash powder 0-3. Then mixing aforesaid material uniformly, filling the mixture into animal casing, and then preparing the sausage by conventional method, i.e., by drying via airing or via heating, and then steaming, cooking, roasting to obtain sausage, roasted sausage, etc.

The aforesaid animal and poultry meat includes one or more kinds of pork, chicken, beef, mutton, turkey meat or rabbit meat.

The advantages of the present invention include: remaining the original flavor of the fish, there existing more taste of fish and being better in taste than the conventional fish sausage with the material of minced fish meat and minced small fish. So the fish sausage of the present invention is the true fish sausage not only being tasteful but also people can feel the existing of the fish in it, which fill the vacancy of the market.

The present invention overcomes the defects of the fish meat being shaped difficultly due to its fine fibres and more moisture content; and in the meantime, the present invention can be used in large scale, and the source of the raw material used in it is broad, and it develops a new method for processing aquatic product.

The present invention combines the advantages of tastefulness, high nutritive value from the fish with the advantages of easy to preserve and carry, convenience for eating, unique in taste of the conventional sausage, and provides a new convenience food. Furthermore, the present invention can provide different taste due to different combination of the materials, can satisfy different demands of consumer. The present invention can solve the problem that some consumers like to eat fish but aren't expert in cooking it.

### DETAILED DESCRIPTION OF THE PREFERRING EMBODIMENTS

The present invention now will be further explained by the following examples.

### EXAMPLE 1

Selecting hairtail meat having certain shape 1500 g, cutting it into small block or strip having length of 0.2-10 cm, and ground meat prepared from pork 500 g by conventional methods, adding refined salt 40 g, white sugar 60 g, alcoholic liquor 16 g, monosodium glutamate 35 g, soya sauce 40 g, ginger juice 20 g, natural flavorant 35 g, mixing them uniformly, filling the mixture into hog casing, drying by air in shady and cool place, and then cooking to obtain hairtail meat sausage according to the invention.

### EXAMPLE 2

Selecting yellow-tin tuna (yellow croaker) meat having certain shape 1000 g, cutting it into small strip or block, and ground meat prepared from turkey meat 250 g, adding salt 20 g, flavorant 20 g, sugar 35 g, alcoholic liquor 35 g, soya sauce 30 g, monosodium glutamate 20 g, paprika 20 g, pricklyash powder 20 g, mixing aforesaid material uniformly, filling the mixture into hog casing, drying by heating, and then cooking to obtain yellow-tin tuna (yellow croaker) meat sausage with spicy-hot flavor.

### EXAMPLE 3

Selecting cod meat having certain shape 1500 g, cutting it into small strip or block, and ground meat prepared from pork 50 g and beef 200 g, adding salt 20 g, flavorant 20 g, sugar 35 g, alcoholic liquor 35 g, soya sauce 30 g, chicken essence 20 g, paprika 20 g, pricklyash powder 20 g, mixing aforesaid material uniformly, filling the mixture into hog casing, drying by air in shady and cool place, then cooking to obtain cod meat sausage with spicy-hot flavor.

### EXAMPLE 4

Selecting salmon meat having certain shape 500 g, cutting it into slice having length of 10 cm and thickness of 0.5 cm, and ground meat prepared from chicken meat 900 g, adding salt 80 g, sugar 50 g, chicken essence 10 g, flavorant 80 g, alcoholic liquor 70 g, soya sauce 20 g, ginger 50 g, paprika 60 g, pricklyash powder 60 g, mixing aforesaid material uniformly, filling the mixture into hog casing, drying by heating, and then cooking to obtain salmon meat sausage with spicy-hot flavor.

### EXAMPLE 5

Selecting Spanish mackerel meat having certain shape 1750 g, cutting it into particle having length of 2 cm and thickness of 1 cm, and ground meat prepared from mutton 80 g, adding salt 30 g, sugar 30 g, monosodium glutamate 30 g, flavorant 20 g, alcoholic liquor 40 g, soya sauce 20 g, mixing aforesaid material uniformly, filling the mixture into hog casing, drying by air in shady and cooling place, and then cooking to obtain Spanish mackerel meat sausage according to the invention.

### EXAMPLE 6

Selecting cyprinoid meat having certain shape 2000 g, cutting it into strip having length of 5 cm and thickness of 1 cm, and ground meat prepared from pork meat 490 g by conventional method, adding salt 80 g, sugar 60 g, chicken essence 10 g, flavorant 20 g, alcoholic liquor 80 g, soya sauce 25 g, ginger 15 g, paprika 10 g, pricklyash powder 10 g, mixing aforesaid material uniformly, filling the mixture into hog casing by conventional process, drying by heating, and then cooking to obtain cyprinoid meat sausage with spicy-hot flavor.

### EXAMPLE 7

Selecting Parasilurus asotus (catfish) meat having certain shape 900 g, cutting it into strip having length of 5 cm and thickness of 0.5 cm, and ground meat prepared from beef 90 g, adding salt 30 g, sugar 10 g, chicken essence 5 g, flavorant 5 g, alcoholic liquor 10 g, soya sauce 20 g, ginger 5 g, paprika 5 g, pricklyash powder 5 g, mixing aforesaid material uniformly, filling the mixture into hog casing by conventional process, drying by heating, and then cooking to obtain Parasilurus asotus (catfish) meat sausage.

Practical Applicability

The present invention combines the advantages of tastefulness, high nutritive value from aquatic product with the advantages of easy to preserve and carry, convenience for eating, unique in taste from the conventional sausage, and provides a new convenience food. Furthermore, the product of the present invention can be ate conveniently, and is helpful to people's health because of its high nutritive value.

1. A kind of fish sausage with fish meat block, which is made of fish meat having certain shape and animal and poultry meat used as main material and supplementary material, characterized in that: preparing the main material by fish meat having certain shape 20-90% weight, and animal and poultry meat 1-49% weight, wherein the fish meat having certain shape is prepared by performing rough handling on the fish, then salting or curing the fish with seasonings; drying salted or cured fish by airing in shady and cool place or by heating; steaming the dried fish for 15-30 minutes, and then removing fish bone and foreign materials after the fish cools down.

2. A kind of fish sausage with fish meat block according to claim 1, wherein the shape of the fish meat includes block, strip, slice and particle having length of 0.2-10 cm, thickness of 0.2-5 cm.

3. A kind of fish sausage with fish meat block according to any one of claim 1 and claim 2, wherein the animal and poultry meat select one or more sorts from pork, chicken, beef, mutton, turkey meat and rabbit meat.

4. A kind of fish sausage with fish meat block according to claim 1, wherein the percentage of weight of the supplementary material is: refined salt 0.1-6, sugar 0.1-6, monosodium glutamate or chicken essence 0.1-5, natural flavorant 0.1-5, alcoholic liquor 0.1-4, soya sauce 0.1-5, ginger juice 0-3, paprika 0-3, pricklyash powder 0-3.

5. A method of preparing fish meat sausage with fish block, characterized in that: selecting a certain amount fish, performing rough handling on the fish, and removing head, gut and scale of the fish; then salting the fish with salt or curing the fish with seasonings, drying salted or cured fish by airing in shady and cool place or by heating, steaming dried fish for 15-30 minutes, removing fish bone and foreign materials after the fish cools down, cutting the obtained fish meat into block, strip, slice, particle which is 0.2-10 cm in length, 0.2-5 cm in thickness, then preparing the main material by the fish meat having certain shape 20-90% weight, and animal and poultry meat 1-49% weight, and adding seasonings used as supplementary material according to different taste, and then preparing the sausage by conventional method.

6. A method according claim 5, wherein the percentage of weight of the supplementary material is: refined salt 0.1-6, sugar 0.1-6, monosodium glutamate or chicken essence 0.1-5, natural flavorant 0.1-5, alcoholic liquor 0.1-4, soya sauce 0.1-5, ginger juice 0-3, paprika 0-3, pricklyash powder 0-3.

7. A method according claim 5, wherein the seasonings used in curing include soya sauce, ground spices, paprika.
